(19) United States
(12) Patent Application Publication
(10) Pub. No.: US 2016/0220978 A1
(43) Pub. Date: Aug. 4, 2016

(54) PROCESS FOR THE ELECTROMAGNETIC MODIFICATION OF LIQUID MINERAL RESOURCES USED AS SOURCES OF POWER AND A DEVICE FOR PUTTING THE SAME INTO PRACTICE

(71) Applicant: Samara State Aerospace University, Samara (RU)

(72) Inventors: Borminsky Sergey ANATOLEVICH, Samara (RU); Skvortsov Boris VLADIMIROVICH, Samara (RU); Solntseva Aleksandra VALEREVNA, Samara (RU)

(73) Assignee: Samara State Aerospace University, Samara (RU)

(21) Appl. No.: 14/754,516

(22) Filed: Jun. 29, 2015

(30) Foreign Application Priority Data
Feb. 2, 2015 (RU) 2015103317

(51) Int. Cl. B01J 19/12; C10L 1/06; B01J 19/08; C10L 10/10

(52) U.S. Cl. CPC B01J 19/12; C10L 10/10; C10L 1/06; B01J 19/087; C10L 2290/40; B01J 2219/0856; B01J 2219/0801; B01J 2219/0877; C10L 2270/023

(57) ABSTRACT

A process for the electromagnetic modification is based on the application of the nuclear magnetic resonance effect when the electromagnetic energy for destroying chemical bonds is lowered, and the frequency selection enables to selectively act on a determined type of molecules. The process uses a two-circuit adjustment of the nuclear magnetic resonance frequency where the first control circuit is used for an accurate adjustment and maintaining of the frequency that breaks the bonds of a specific type of molecules, the second control circuit enabling, with the help of a quality analyzer, to select the type of molecules to be modified.

### CROSS-REFERENCE TO RELATED APPLICATIONS

The present invention claims priority from Russian Patent Application No. 2015103317 filed Feb. 2, 2015, which is incorporated herein by reference.

### TECHNICAL FIELD

This invention relates to systems for automatic control of technological processes and can find application in the technology for producing petroleum derivatives of an improved quality and dealing with the modification of hydrocarbons obtained by usual methods of petroleum refining.

### BACKGROUND OF THE INVENTION

The prior art for the present invention comprises processes and devices to modify hydrocarbons, based on electromagnetic processing of a product, including radiation, X-ray, optical, radio-frequency and magnetic processing, disclosed in RU2039789 of 20.07.1995; RU2116330 of 27.07.1998; RU2098454, published on 10 Dec. 1997; RU2202593, published on 20.04.2003; RU2339678 of 27.04.2008; RU73486 of 20 May 2008; U.S. Pat. No. 5,673,674; U.S. Pat. No. 5,055,180; U.S. Pat. No. 3,055,814; U.S. Pat. No. 8,361,282; as well as processes and devices disclosed in the publication “Magnetic processing of liquids in oil production” by R. V. Spiridonova, S. A. Demahina, A. Yu. Kivokurtseva, Publishing house GosUNTs “College”, 2003. The above mentioned processes and devices are based on the use of electromagnetic field energy that heats a product, as a rule, in the presence of a catalyst, which finally results in fractionation of components and in usual thermochemical isomerization processes related to the molecule structure modification.

Said prior art shows a drawback consisting in a low efficiency due to the need to heat a product; furthermore, all the component composition experiences modifications and additional production waste is obtained that reduces the output of the final product. The drawbacks of the direct optical and magnetic processing of fuels that occurs without heating are caused by a low efficiency of the same since such a processing does not result in any substantial modifications of the main quality indices for the petroleum products obtained, such as detonation resistance, density, viscosity.

The closest prior art of the process of the present invention is a process for the electromagnetic modification of liquid mineral resources used as sources of power based on the nuclear magnetic resonance effect disclosed in the patent RU140192 of 10 May 2014, consisting in the simultaneous exposure of the product to both an orthogonal variable electromagnetic flux and a constant magnetic flux that modify the structure of molecules.

The closest prior art of the device of the present invention is a device for electromagnetic modification of hydrocarbons at the nuclear magnetic resonance frequencies disclosed in RU140192 of 10 May 2014, that comprises a capacity with hydrocarbon raw materials; a system for supply and for removal of a petroleum product; an alternator the output of which is connected up to a variable magnetic field exciter; a constant magnetic field source for providing the nuclear magnetic resonance effect (NMR), the magnetic flux of which is orthogonal to the magnetic flux of a solenoid; a NMR control unit providing measurements of the current and of the power factor the input of which is connected to the output of the alternator; and a frequency control unit the input of which is connected to the output of the measuring unit, the output being connected to the frequency setting input of the alternator. A drawback of the closest prior art consists in an inadequate quality of the product at the outlet of the plant due to the lack of the obtained result monitoring during the operation of the device and to the impossibility to provide a reiterated processing in the case of a chemical composition that does not satisfy the quality criteria.

### SUMMARY OF THE INVENTION

A task was put forward to increase the efficiency of the procedure for electromagnetic modifying hydrocarbon fuels in order to provide prescribed qualitative parameters for the minimum power consumption and production waste.

The task assigned is solved thanks to the fact that in a known process consisting in a simultaneous irradiation of a product with orthogonal fields, both variable electromagnetic and constant magnetic ones that modify the molecular structure, according to the present invention, a continuous monitoring of the product quality indices is carried out at the outlet of the reactor and on the base of the results of which, in the case of non-conformity of the qualitative parameters obtained to required ones, the product is recycled back into the reactor, the intensity of the radiated signal being selected in such a way to provide the nuclear magnetic resonance for a selective effect solely to the group of components that exerts an influence on the attainment of the required quality indices.

To put the claimed process into practice with a device comprising a capacity with hydrocarbon raw materials, an alternator the output of which is connected up, via a nuclear magnetic resonance control unit, to a variable magnetic field exciter; a constant magnetic field source the magnetic flux of which is orthogonal to the magnetic flux of the variable magnetic field exciter; a nuclear magnetic resonance control unit the information output of which is connected to the input of a frequency control unit, the output of which is connected to the frequency setting input of the alternator, according to the invention, the device additionally comprises a line analyzer of the product quality the inlet for liquids of which is connected to the outlet of the capacity while the electric signal output is connected to the process control unit, an output of which is connected to the frequency control unit, another output of which being connected to a selector valve the outlet for liquids of which is connected to the outlet of the line analyzer, one outlet for liquids is connected to the system inlet, the second outlet for liquids representing the outlet for the finished product.

### BRIEF DESCRIPTION OF THE DRAWINGS

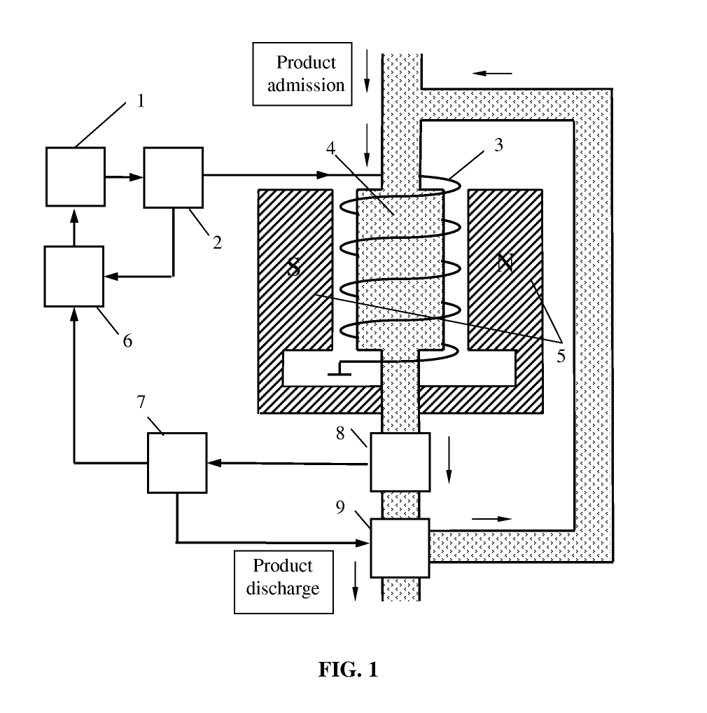

An exemplary embodiment of the present invention is illustrated in FIG. 1 in which a block diagram of a device for electromagnetic modification of liquid mineral resources used as sources of power is shown.

### DETAILED DESCRIPTION

The device to put the process into practice comprises an electric signal generator 1 the output of which is connected, via a nuclear magnetic resonance control unit 2, to a variable magnetic field exciter (an inductor) 3 embracing the reactor capacity 4 located between the poles of a constant magnetic field source 5. From the nuclear magnetic resonance control unit output, a signal is supplied to the frequency control unit 6 that directly controls the generator frequency. Likewise, the frequency control unit 6 receives a signal from a process control unit 7 that in turn receives data from a product quality line analyzer 8 and controls a selector valve 9.

The principle of the modification comprises changing a specific quality index of a petroleum product by molecular restructuring of a group of components in a given volume with the help of an electromagnetic signal. Since an electromagnetic radiation impulse can destroy any bond in a molecule, it is possible to obtain a practically unlimited assortment of free radicals. The modification of a medium by the electromagnetic method is based on the energy interaction of a molecule with the radiation. When a hydrocarbon product is placed into a constant magnetic field, conditions are formed in the medium for the origination of NMR. NMR appears as a result of a radio-frequency radiation absorption by a substance located in a magnetic field. The main equation determining the nuclear magnetic resonance frequency has the following view:

$$ω = \frac{γ}{2 π} {H}_{0} ( 1 - σ ) \qquad ( 1 )$$

where γ is a gyromagnetic ratio characterizing the considered class of nuclei;

H₀ is the constant magnetic field strength;

σ is a screening constant determined by the location and the chemical bonds of the resonating nucleus in a molecule.

When the frequency of an electromagnetic signal in the capacity is selected in a way to get the frequency resonating for a specific molecule of a multi-component mixture, a purposeful modification occurs together with the provision of needed properties of a product and practically without production waste.

The process of electromagnetic modification consists in the following. The reactor capacity 4 is located inside a solenoid 3 placed between the poles of a constant magnetic field source 5 the magnetic field of which is orthogonal to the magnetic field of the solenoid 3 in which, with the help of the generator 1 and the electric elements of the solenoid 3, a variable electromagnetic field is generated that attacks the product under processing.

The frequency and intensity of the electric signal generator 1 are first established after reference data in order to provide NMR to modify the necessary group of components determining the needed quality indices of a hydrocarbon fuel. The fuel is modified as to a given index (for example, the octane number) when passing through the solenoid 3 placed between the poles of the constant magnetic field source 5 the magnetic field of which is orthogonal to the solenoid magnetic field.

The device has two feedback loops. The first loop, on the basis of data supplied from the nuclear magnetic resonance control unit that measures current, voltage and power factor in the solenoid, carries out, with the help of the frequency control unit 6, an accurate adjustment of the generator to the nuclear magnetic resonance frequency for a given class of molecules in order to maintain the maximum consumption of the electromagnetic wave power in the substance.

The second feedback loop comprises a line analyzer of the product quality 8, a selector valve 9 and a process control unit 7, incorporated in the device. At the outlet of the capacity 4, the line analyzer 8 examines the chemical composition the information of which is transmitted to the process control unit 7. If the qualitative criteria of the final product are not satisfactory, the process control unit recycles the product back into the capacity with the help of a selector valve 9; in this case, to provide further modifications, new generator frequency and power parameters are set for cracking other types of molecules disturbing the provision of needed quality indices. The product can circulate many times through the reactor capacity 4 and the line analyzer 8 until getting required characteristics. For example, initially the system is adjusted to modify the n-hexane molecule. The line quality analyzer determines the product octane number and, if the needed octane number is not obtained, the system is readjusted to modify the n-heptane molecule, etc. It is necessary to note that the drawing does not show pumps to transfer liquid by pumping, the presence of which in the diagram is evident.

The main difference of the process of the present invention from known ones is the two-circuit NMR frequency adjustment where the first circuit is used to accurately adjust for a frequency destroying the bonds of a specific type of molecules, the second circuit enabling, with the help of the quality analyzer, to select a respective type of molecules to be modified.

The process and the device according to the present invention can be used to modify commercial fuels such as gasoline, kerosene, diesel fuel and other liquid mineral resources used as power sources in order to change density, viscosity, octane number, flash point and other parameters. For example, hexane (C₆H₁₄), one of the gasoline components with the octane number of 24.8, can be transformed, by electromagnetic modification, into isohexane that is a gasoline component as well and has the same chemical formula together with the octane number of 91.1, which can increase the total octane number of a gasoline. To induce the nuclear magnetic resonance of hexane molecules, the authors of the present invention use a constant magnetic field with the induction of 1.4±0.05 T1 and the electromagnetic field frequency of 89560180±5 Hz, nevertheless, the resonance is possible at other field characteristics as well.

The incorporation of a line analyzer to the device structure enables to monitor the product qualitative characteristics at the outlet from the reactor capacity. The incorporation of a process control unit and of a selector valve enables to carry out repeated processing of fuels, while adjusting the generator at every cycle to modify those molecules that do not allow to obtain required chemical properties of the final product. All this provides for the desired technical result that is to allow repeated circulation of the product through the reactor capacity with the adjustment of new electromagnetic radiation parameters to gradually bring the final product chemical properties to required values, which improves the petroleum product quality at the outlet of the device.

1. A process for the electromagnetic modification of liquid mineral resources used as sources of power on the basis of the nuclear magnetic resonance effect comprising a simultaneous irradiation of a product with orthogonal fields, both variable electromagnetic and constant magnetic ones that modify the molecular structure, comprising:
at the outlet of the reactor, a continuous monitoring of the product quality indices is carried out on the base of the results of which, in the case of non-conformity of the qualitative parameters obtained to required ones, the product is recycled back into the reactor,
the intensity of the radiated signal being selected in such a way to provide the nuclear magnetic resonance for a selective effect solely to the group of components that exerts an influence on the attainment of the required quality indices.

2. A device putting in practice the process of claim 1, comprising
a reactor capacity with hydrocarbon raw materials,
an alternator the output of which is connected up, via a nuclear magnetic resonance control unit, to a variable magnetic field exciter;
a constant magnetic field source the magnetic flux of which is orthogonal to the magnetic flux of the variable magnetic field exciter;
a nuclear magnetic resonance control unit the information output of which is connected to the input of a frequency control unit, the output of which is connected to the frequency setting input of the alternator,
a line analyzer of the product quality the inlet for liquids of which is connected to the outlet of the reactor capacity while the electric signal output is connected to the process control unit, an output of which is connected to the frequency control unit, another output of which being connected to a selector valve the outlet for liquids of which is connected to the outlet of the line analyzer, one outlet for liquids is connected to the system inlet, the second outlet for liquids representing the outlet for the final product.
